(19) United States
(12) Patent Application Publication
(10) Pub. No.: US 2013/0062933 A1
(43) Pub. Date: Mar. 14, 2013

(54) COMPACT ATTENUATOR FOR A VEHICLE BRAKING SYSTEM

(71) Applicant: Naseem Daher, Lafayette, IN (US)

(72) Inventor: Naseem Daher, Lafayette, IN (US)

(73) Assignee: KELSEY-HAYES COMPANY, Livonia, MI (US)

(21) Appl. No.: 13/231,297

(22) Filed: Sep. 13, 2011

(51) Int. Cl. B60T 17/04; B60T 13/16; B60T 8/176; B60T 15/00

(52) U.S. Cl. 303/10; 303/87; 303/113.1

(57) ABSTRACT

An attenuator assembly is located in an attenuator chamber of a housing in a vehicle braking system and includes an orifice defining a fluid dampening flow path. The orifice has an outlet opening. A biasing member defines a closing member of the orifice. The size of the outlet opening changes continuously between a first open position and a second open position.

### BACKGROUND

Various embodiments of an attenuator are described herein. In particular, the embodiments described herein are mounted in a hydraulic control unit of an electronically controlled brake system.

Devices for autonomously generating brake pressure have been a part of the prior art since the introduction of driver assistance functions, such as, for example, a vehicle stability control (VSC). Autonomously generating brake pressure makes it possible to brake individual wheels or all wheels of the vehicle independently of the driver actuating the brake. Additional driver assistance functions beyond the safety-related VSC have been developed for safety as well as comfort functions, such as for example adaptive cruise control (ACC).

When the ACC function is activated, the distance and relative speed of a vehicle traveling up ahead is recorded by laser distance sensors or preferably radar distance sensors. The ACC function maintains a speed selected by the driver until a slower vehicle traveling up ahead is identified and a safe distance from it is no longer being maintained. In this case, the ACC function engages by braking to a limited extent and, if needed, by subsequent acceleration in order to maintain a defined spatial or temporal distance from the vehicle traveling up ahead. Additional ACC functions are expanded to the extent of also braking the vehicle to a stop. This is used for example in the case of a so-called follow-to-stop function or a function to minimize the occurrence of a collision.

Further developments also permit a so-called stop-and-go function, wherein the vehicle also starts automatically if the vehicle up ahead is set in motion again. To do so, the stop-and-go function typically executes a frequently changing autonomous pressure build-up to approximately 30 to 40 bar in the vehicle braking system independent of the generation of brake pressure originating from the driver. In the case of typical speeds on freeways, an autonomous deceleration is often restricted to approximately 0.2 g. At lower speeds, however, the system can generate an autonomous deceleration of 0.6 g for example. A further development also includes an automatic emergency brake (AEB), whereby the AEB function detects potential accident situations in due time, warns the driver, and initiates measures to autonomously brake the vehicle with full force. In this case, rapid brake pressure build-up rates may occur.

Devices for autonomously generating brake pressure include pumps, such as piston pumps. In particular, the conveyance of brake fluid through piston pumps generates pulsations, which can spread audibly via brake circuits and also affect the noise level in the vehicle's interior. To dampen noise or pulsations, devices for autonomously generating brake pressure are known that feature an attenuator or an orifice on the outlet side of the pump.

The use of attenuators, which reduce amplitude of pressure fluctuations in hydraulic fluid lines of vehicular braking systems, is well known. In particular, attenuators are common in vehicular anti-lock braking systems (ABS) at the outlet end of an ABS hydraulic pump used to evacuate a low pressure accumulator. A hydraulic control unit (HCU) includes a housing having bores for mounting valves and the like and channels for directing fluid. An attenuator may be mounted in a bore in the HCU to significantly reduce the amplitude of high energy pressure pulses in the brake fluid at the outlet of the pump. These pressure pulses can create undesirable noise, which is transmitted to the master cylinder or its connection to the vehicle. These pressure pulses can also cause undesirable brake pedal vibrations.

A typical attenuator includes a chamber filled with brake fluid. An inlet passage delivers fluid from the outlet end of the pump to the chamber, and an orifice of substantially reduced diameter directs fluid from the chamber to an outlet passage. The restriction of fluid flow through the orifice attenuates pressure fluctuations as a result of the compressibility of the brake fluid. Thus, brake fluid in the chamber absorbs high energy fluid pulses and slowly releases the fluid through the orifice.

U.S. Pat. No. 5,540,486 shows, in FIG. 1 for example, a pump 24 with an attenuator 26 arranged downstream from the pump 24, and an orifice 28. The attenuator 26 includes an elastomer core piece 410′. The core piece 410′ includes an annular seal 66′ at the head end 412′ of the attenuator and an axially extending compression rib 52′.

Printed document WO 02/14130 A1 shows a vehicle braking system, which comprises a device for autonomously generating brake pressure with a pump 8, a compensating tank 48 arranged downstream from the pump 8 and a throttle 49. By using the throttle, pump noises are dampened and an improvement in comfort is achieved. The throttle, however, has a limiting effect on pressure build-up rates.

Another known attenuator for use in an ABS system is disclosed in U.S. Pat. No. 5,921,636 to Roberts. The attenuator 70 includes a cylinder 72 slidably received in a bore 73 of the housing 400. An elastomeric plug 80 is received in and fills a substantial volume of a bore or chamber 75 of the cylinder 72. The volume of the interior chamber 75 not filled by the core piece 80 provides a streamlined path for fluid flowing through attenuator 70. This streamlined path substantially eliminates fluid turbulence typically found in reservoirs of known attenuators due to a relatively large volume of air entering the reservoirs from aeration of the brake fluid.

German Patent Application DE 10 2009 006 980 A1 shows an attenuator 7 in an HCU of a brake system. The attenuator 7 includes an attenuation chamber 8 having a fixed orifice 9 and a switchable orifice 10. The fixed orifice 9 is about twice as large as the switchable orifice 10. The switching function of the switchable orifice 10 is performed by a ball-check valve 11. The ball-check valve 11 is controlled by differential pressure and is configured to open at a predetermined cracking pressure. If the pressure difference at the ball-check valve 11 is not sufficient to open the ball-check valve 11, then fluid will flow initially through the switchable orifice 10, then through the fixed orifice 9 with the relatively larger orifice opening. When the pressure difference on the ball-check valve 11 reaches the predetermined cracking pressure, the ball 13 will lift up from its valve seat 14 so that the pulsating flow rate/volumetric flow moves directly from the attenuation chamber 8 through the orifice 9 with a large orifice opening. The ball-check valve 11 prevents fluid flow back through the orifice 9 to the attenuation chamber 8. Additionally, the ball 13 of the ball-check valve 11 operates in one of two positions: (1) a closed position when the pressure difference at the ball-check valve 11 is not sufficient to move the ball 13 against the force of the spring, and (2) a fully open position when the pressure difference on the ball-check valve 11 reaches the predetermined cracking pressure, and the ball 13 is lifted up from its valve seat 14 to allow fluid to flow through the ball-check valve 11.

There remains a need for an improved attenuator to dampen the vibrations and pressure pulses that occur in vehicular anti-lock braking systems.

### SUMMARY

The present application describes various embodiments of a vehicle braking system. In one embodiment, an attenuator assembly is located in an attenuator chamber of a housing in a vehicle braking system and includes an orifice defining a fluid dampening flow path. The orifice has an outlet opening. A biasing member defines a closing member of the orifice. The size of the outlet opening changes continuously between a first open position and a second open position.

In another embodiment, a vehicle braking system includes a variable speed motor driven piston pump for supplying pressurized fluid pressure to the wheel brakes through a valve arrangement and an attenuator assembly connected to a pump outlet for dampening pump output pressure pulses prior to application of the wheel brakes. The attenuator assembly is located in an attenuator chamber of a housing and includes an orifice that defines a fluid dampening flow path and has an outlet opening. A biasing member defines a closing member of the orifice. The size of the outlet opening changes continuously between a first open position and a second open position.

In a further embodiment, a vehicle braking system includes a slip control system. The slip control system is operable in an electronic stability control (ESC) mode to automatically and selectively apply wheel brakes in an attempt to stabilize a vehicle when an instability condition has been sensed. The slip control system includes a variable speed motor driven piston pump for supplying pressurized fluid pressure to the wheel brakes through a valve arrangement. The slip control system further includes an attenuator assembly connected to a pump outlet for dampening pump output pressure pulses prior to application of the wheel brakes. The attenuator assembly is located in an attenuator chamber of a housing and includes an orifice that has a fluid dampening flow path and an outlet opening. A biasing member defines a closing member of the orifice. The size of the outlet opening changes continuously between a first open position and a second open position.

Other advantages of the vehicle braking system will become apparent to those skilled in the art from the following detailed description, when read in view of the accompanying drawings.

### BRIEF DESCRIPTION OF THE DRAWINGS

FIG. 1 is a hydraulic circuit diagram of a vehicle braking system with an attenuator assembly according to the invention.

FIG. 2 is an enlarged cross sectional view of a first embodiment of the attenuator assembly illustrated in FIG. 1, showing the attenuator assembly in a first position.

FIG. 3 is an enlarged cross sectional view of the first embodiment of the attenuator assembly illustrated in FIG. 2, showing the attenuator assembly in a second position.

FIG. 4 is an enlarged cross sectional view of a second embodiment of an attenuator assembly.

FIG. 5 is an enlarged cross sectional view of a third embodiment of the attenuator assembly.

FIG. 6 is an enlarged perspective view of an alternative structure of the flat spring illustrated in FIGS. 2 and 3.

FIG. 7 is an enlarged perspective view of another alternative structure of the flat spring illustrated in FIGS. 2 and 3.

FIG. 8 is a graph illustrating curves of flow rate to differential pressure for the variable orifice of the invention and a two-stage orifice of the prior art.

FIG. 9 is an enlarged cross sectional view of a fourth embodiment of an attenuator assembly.

### DETAILED DESCRIPTION

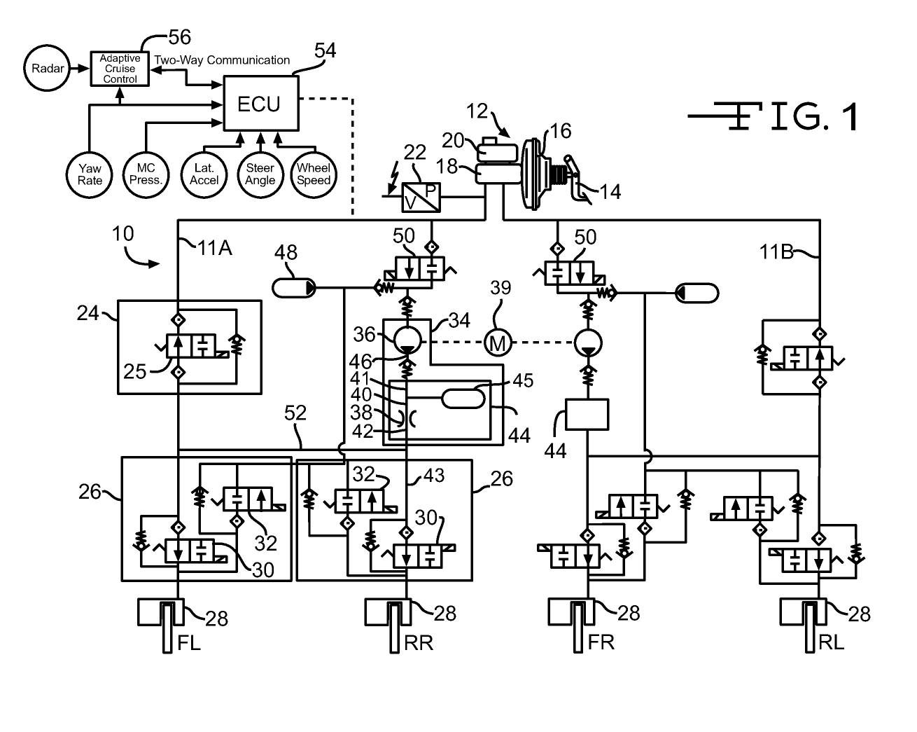

A hydraulic vehicle braking system is indicated generally at 10 in FIG. 1. The illustrated embodiment of the vehicle brake system 10 includes valves and other components described below to provide an electronic stability control (ESC) capability. The vehicle braking system 10 includes a slip control system operable in an ESC mode to automatically and selectively apply the brakes in an attempt to stabilize the vehicle when an instability condition has been sensed by any of the sensors providing data to an electronic control unit (ECU) 54. The vehicle brake system 10 is intended to be exemplary and it will be appreciated that there are other brake control system configurations that may be used to implement the various valve embodiments described herein. In other embodiments, the brake system 10 may include components to provide anti-lock braking, traction control, and/or vehicle stability control functions.

The slip control system is further operable in an adaptive cruise control (ACC) mode to automatically apply the brakes to slow the vehicle in response to a control signal, as shown in FIG. 1. The slip control system includes a variable speed motor driven piston pump 36, described below, for supplying pressurized fluid pressure to brake cylinders 28 of the brakes through a valve arrangement. In the ESC mode, a pump motor 39 operates in an ESC speed range with a relatively higher flow rate. In the ACC mode, the pump motor 39 operates in an ACC speed range. The ACC speed range and flow rate are lower than the ESC speed range and flow rate, respectively. The slip control system further includes an attenuator assembly 44 connected to a pump outlet 46 for dampening pump output pressure pulses prior to application to the brakes.

The vehicle brake system 10 has two separate brake circuits 11A and 11B, respectively, which are depicted on the left and right halves of FIG. 1. In the exemplary embodiment illustrated in FIG. 1, the circuits 11A and 11B supply brake pressure to front and rear wheel brakes. The illustrated rear wheel brake is arranged diagonally to the front wheel brake. Only the left brake circuit 11A in FIG. 1 is described in the following in more detail. However, the right brake circuit 11B in FIG. 1 can be structured in the same manner.

The brake system 10 includes a driver-controlled first pressure generating unit 12 with a brake pedal 14, a power brake unit 16, and a tandem master brake cylinder 18 which presses the brake fluid out of a reservoir 20 into the two brake circuits 11A and 11B. Arranged behind an outlet of the tandem master brake cylinder 18 is a pressure sensor 22 for detecting the driver's input.

Under normal driving conditions, brake fluid pressure emanating from the driver-controlled first pressure generating unit 12 continues via a block valve arrangement 24 and a pair of anti-lock brake system (ABS) valve arrangements 26 to the front left (FL) and rear right (RR) wheel brake cylinders 28. Each of the ABS valve arrangements 26 includes an ABS inlet or isolation valve 30 and an ABS discharge or dump valve 32. The ABS inlet valve 30 is normally open, and the ABS discharge valve 32 is normally closed. Each wheel brake cylinder 28 includes an ABS valve arrangement 26, and the brake fluid pressure of both brake circuits is distributed diagonally in the vehicle to a respective pair of wheel brake cylinders 28, the FL and RR, or the front right (FR) and rear left (RL), respectively. The illustrated block valve arrangement 24 is part of a traction control or vehicle stability control system and includes an isolation valve 25 that is normally open in a currentless state. In a current-carrying state, the block valve arrangement 24 is blocked from a backflow of brake fluid from the wheel brake cylinders 28 to the master brake cylinder 18.

Brake fluid pressure may be built up independently of the driver-controlled first pressure generating unit 12 by an autonomous second pressure generating unit 34. The autonomous second pressure generating unit 34 includes the pump 36 driven by the pump motor 39 and the attenuator assembly 44. The attenuator assembly 44 includes an attenuator 45 and an orifice 38. The orifice 38 has an inlet side 40 and an outlet side 42. The orifice 38 may be any desired orifice, such as the two-stage orifice disclosed in commonly assigned International Patent Application No. PCT/US2010/045159, filed Aug. 11, 2010, and which is incorporated herein by reference. The attenuator assembly 44 is in fluid communication with a pump outlet 46 via a conduit 41 and a conduit 43 via the orifice 38. Pulsations emanating from the pump 36 are periodic fluctuations in the brake fluid flow. The attenuator assembly 44 takes in brake fluid during the pulsation peaks and releases it again between the pulsation peaks. As a result, the attenuator 44 levels out a temporal pressure progression on the inlet side 40 of the orifice 38.

Arranged on the intake side of the pump 36 are a low pressure accumulator (LPA) 48 and a pump inlet or supply valve 50. The illustrated pump inlet valve 50 is a normally closed valve. When the pump inlet valve 50 is currentless and closed, the pump 36 is supplied with brake fluid from the LPA 48. When the pump inlet valve 50 is current-carrying and open, the pump 36 can also suction brake fluid from the master brake cylinder 18.

The driver-controlled first pressure generating unit 12 and the autonomous second pressure generating unit 34 convey brake fluid in a common brake branch 52 of one of the two brake circuits. As a result, both pressure generating units 12, 34 can build up brake fluid pressure to the wheel brake cylinders 28 of the brake circuit independently of one another.

The vehicle brake system 10 uses the autonomous second pressure generating unit 34 for generating brake pressure within the scope of a vehicle stability control (VSC function). Moreover, the autonomous second pressure generating unit 34 can also be used for the adaptive cruise control (ACC function). In the process, the autonomous second pressure generating unit 34 can build up brake fluid pressure for autonomously braking the vehicle in the course of a stop-and-go function in frequent succession and not just in extraordinary, relatively rare driving situations. This also occurs with predominantly low to moderate driving speeds, at which the basic noise level in the vehicle interior is relatively low. Under such conditions, known pressure generating units represent a source of noise and pulsation that can be annoying in terms of driving comfort.

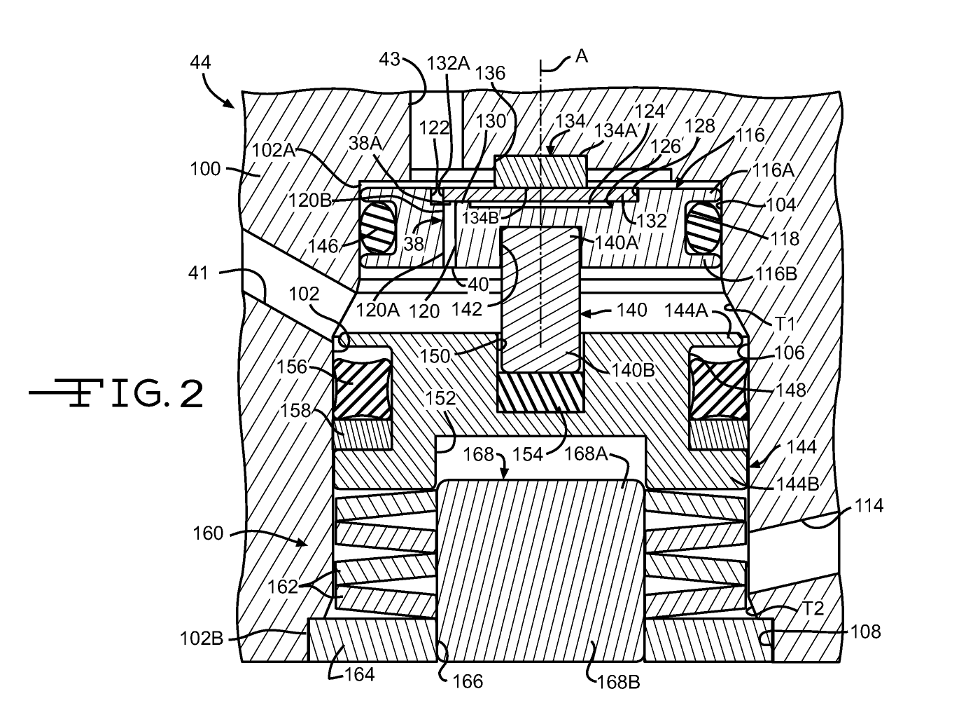

It will be understood that the vehicle brake system 10 may include a hydraulic control unit (HCU) (not shown in FIG. 1) connected in fluid communication between the master brake cylinder 18 and wheel brake cylinders 28. As best shown in FIG. 2 and described in detail below, the HCU typically includes a hydraulic valve block or housing containing the various control valves and other components described herein for selectively controlling hydraulic brake pressure at the wheel brake cylinders 28.

As shown at 54 in FIG. 1, the vehicle brake system 10 may include an electronic control unit (ECU) which receives input signals from sensors, such as yaw rate, master cylinder pressure, lateral acceleration, steer angle, and wheel speed sensors. The ECU may also receive ground speed data from an ACC system 56. The ACC system may receive input data from a radar and the vehicle yaw rate sensor. One example of a vehicular control system adapted to control fluid pressure in an electronically-controlled vehicular braking system and an electronically-controlled ACC system is disclosed in commonly assigned U.S. Pat. No. 6,304,808 to Milot, which is incorporated herein by reference in its entirety.

Referring now to FIG. 2, there is illustrated at 44 a first embodiment of the attenuator assembly. In the illustrated embodiment, the attenuator assembly 44 is disposed in an attenuator bore or chamber 102 of the housing or valve body 100. In the illustrated embodiment, the valve body 100 is a hydraulic control unit (HCU). The bore 102 has an axis A, a first end 102A (upper end when viewing FIG. 2) and a second or open end 102B, and may have more than one inside diameter. For example, the illustrated bore 102 includes a first portion 104 having a first diameter, a second portion 106 having a second diameter, wherein the second diameter is larger than the first diameter, and a third portion 108 having a third diameter, wherein the third diameter is larger than the second diameter. The bore 102 also includes a first tapered portion T1 extending between the first portion 104 and the second portion 106 and a second tapered portion T2 extending between the second portion 106 and the third portion 108.

The inlet conduit or passageway 41 is formed in the HCU 100 and allows pressurized fluid flow between the pump 36 and the bore 102. The first outlet conduit or passageway 43 is formed in the HCU 100 and connects the bore 102, via the orifice 38, to the wheel brakes FL, RR, FR, RL. A second outlet or vent passageway 114 is also formed in the HCU 100 and connects the bore 102 to a cavity (not shown).

The attenuator assembly 44 includes a first attenuator member 116 disposed within the first end 102A of the attenuator bore 102. The first attenuator member 116 is substantially disc shaped and has a first end 116A (upper end when viewing FIG. 2) and a second end 116B opposite the first end 116A. A circumferentially extending seal groove 118 is formed in the outer circumferential surface of the first attenuator member 116.

A dampening passageway 120 is formed through the first attenuator member 116 from the second end 116B to the first end 116A. The dampening passageway 120 has an inlet opening or end 120A and an outlet opening or end 120B and defines a fluid dampening flow path. The dampening passageway 120 may have any desired diameter, such as a diameter of about 0.50 mm. Alternatively, the dampening passageway 120 may have a diameter within the range of from about 0.25 mm to about 0.75 mm. In another embodiment, the dampening passageway 120 may have a diameter within the range of from about 0.1 mm to about 1.0 mm. A first cavity 122 is formed in the first end 116A of the first attenuator member 116 and is in fluid communication with the outlet end 120B of the dampening passageway 120. A second cavity 124 is also formed in the first end 116A of the first attenuator member 116 and defines a spring seat. The illustrated second cavity 124 includes a first substantially cylindrical portion 126 and a second substantially cylindrical portion 128 adjacent the first end 116A. The second substantially cylindrical portion 128 has a diameter larger than the first substantially cylindrical portion 126 and defines a shoulder 130. A first movable member 132 is mounted within the second substantially cylindrical portion 128 of the second cavity 124. In the illustrated embodiment, the first movable member is a disc spring. The first movable member 132 extends partially into the first cavity 122 and therefore partially into a dampening fluid flow path defined by the dampening passageway 120, thereby defining a first open position.

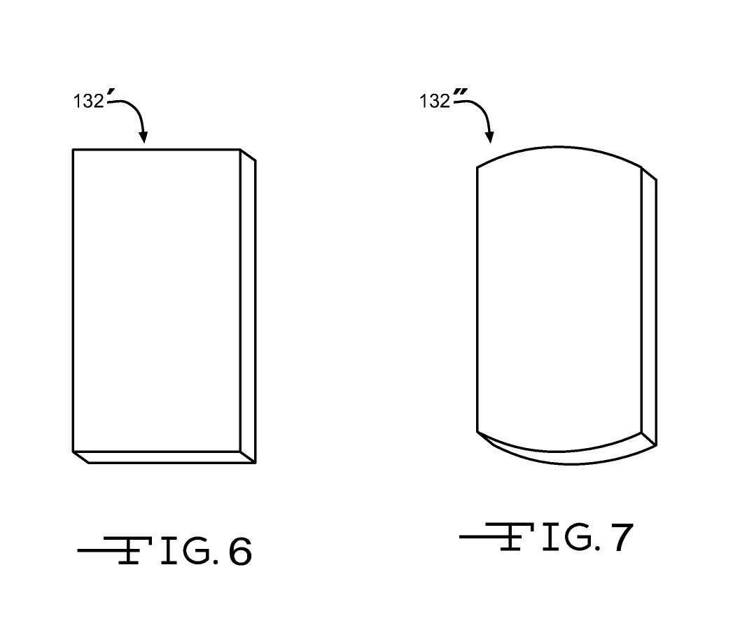

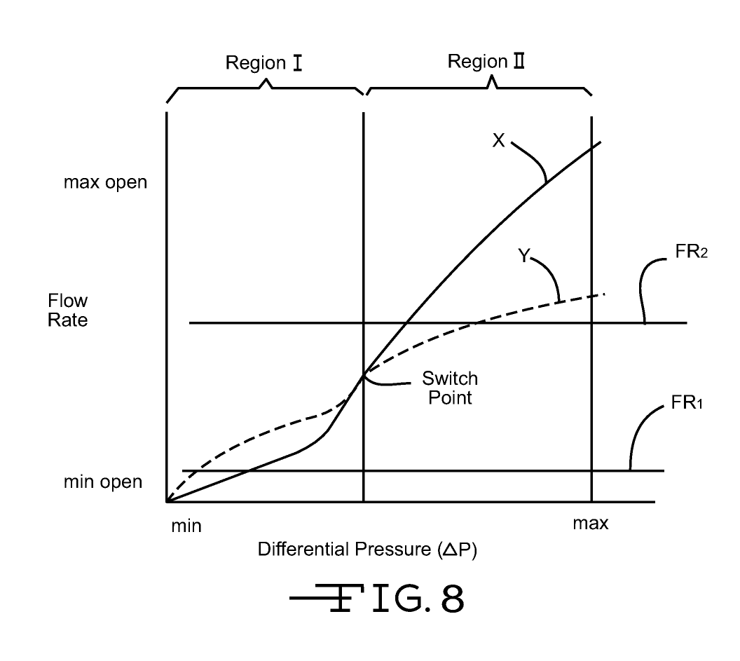

Alternatively, the first movable member may have a shape other than the disc shape illustrated. For example, the first movable member may be any desired substantially flat spring, such as a substantially flat spring having a substantially rectangular shape, or a substantially flat spring having a combination of straight and arcuate edges, such as shown at 132′ and 132″ in FIGS. 6 and 7, respectively. It will be understood that the first movable members 132′ and 132″ are shown enlarged and with exaggerated thickness for clarity.

A first substantially cylindrical member defines a fulcrum 134. A first end 134A of the fulcrum 134 is mounted, such as by a press-fit, within a fulcrum bore 136 in a wall of the first end 102A of the attenuator bore 102. A second end 134B of the fulcrum 134 extends inwardly (downwardly when viewing FIG. 2) into the attenuator bore 102 and engages the first movable member 132. In the illustrated embodiment, the first movable member 132 is a pre-loaded disc spring. The fulcrum 134 exerts a force (downward when viewing FIG. 2) on the first movable member 132 and urges the first movable member 132 into a substantially flat shape and into the second substantially cylindrical portion 128. The dampening passageway 120, the first cavity 122, and the first movable member 132 cooperate to define the orifice 38, the operation of which is described herein. In FIG. 2, the orifice 38 is shown in a first open position 38A.

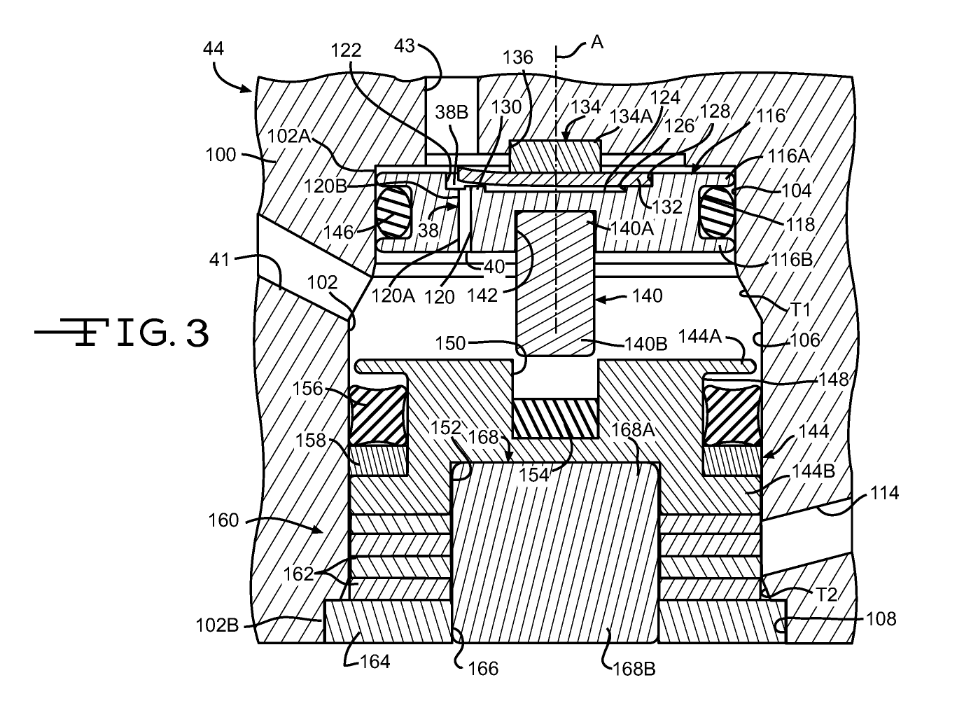

In the illustrated embodiment, the first movable member 132 is illustrated as being pre-loaded into a substantially flat shape by the fulcrum 134. Alternatively, the first movable member 132 may be pre-loaded such that an outer peripheral edge 132A of the fulcrum 134 is urged away from the attenuator bore 102 (upwardly when viewing FIG. 9). The first movable member 132 and the outlet end 120B of the dampening passageway 120 therefore cooperate to define an alternate first open position 38B larger than the first open position 38A, as shown in FIG. 3. It will be understood that the first movable member 132 may be pre-loaded any desired amount by varying the size and/or the relative position of the fulcrum 134. Accordingly, the first movable member 132 may be pre-loaded to define a first open position having any desired size.

A first end 140A of a substantially cylindrical first pin 140 is mounted, such as by a press-fit, within a pin bore 142 in the second end 116B of the first attenuator member 116. A second end 140B of the first pin 140 extends inwardly (downwardly when viewing FIG. 2) into the attenuator bore 102 and engages a piston 144 as described below.

A first sealing member 146 is disposed within the groove 118 and seals the first attenuator member 116 relative to the bore 102. In the illustrated embodiment, the first sealing member 146 is an elastomeric O-ring 146. Alternatively, other types of sealing members may be used, such as a quad seal or quad-ring seal, lip seal, and the like.

The illustrated first attenuator member 116 is formed from aluminum. Alternatively, the first attenuator member 116 may be formed from any desired material such as carbon steel, stainless steel, brass, copper, and other metals, metal alloys, and non-metals.

The illustrated first movable member 132 is formed from steel, such as spring steel. Alternatively, the first movable member 132 may be formed from any desired material such as refined steel, corrosion resistant steel, heat resistant steel, copper alloy, nickel and cobalt alloy and other metals, metal alloys, and non-metals.

The illustrated fulcrum 134 is formed from steel. Alternatively, the fulcrum 134 may be formed from any desired material such as aluminum, copper, nickel and cobalt alloy and other metals, metal alloys, and non-metals.

The illustrated first pin 140 is formed from steel. Alternatively, the first pin 140 may be formed from any desired material such as aluminum, copper, nickel and cobalt alloy and other metals, metal alloys, and non-metals.

The piston 144 is slidably disposed within the attenuator bore 102. The piston 144 is substantially cylindrical and has a first end 144A (upper end when viewing FIG. 2) and a second end 144B. A circumferentially extending seal groove 148 is formed in the outer circumferential surface of the piston 144.

A first pin cavity 150 is formed in the first end 144A of the piston 144. A second pin cavity 152 is formed in the second end 144B of the piston 144. A resilient member 154 is disposed in the first pin cavity 150. In the illustrated embodiment, the resilient member 154 defines a moderately deformable member and is formed from an elastomeric material, such as EPDM rubber. Alternatively, the resilient member 154 may be formed from any other deformable material, such as urethane, nitrile, or other polymer.

The second end 140B of the first pin 140 extends into the first pin cavity 150 and engages the resilient member 154. The pin 140 defines a stop that prevents the piston 144 from moving further inwardly (upwardly when viewing FIG. 2).

A second sealing member 156 is disposed within the seal groove 148 and seals the sliding piston 144 relative to the bore 102. In the illustrated embodiment, the second sealing member 156 is an elastomeric quad seal 156. Alternatively, other types of sealing members may be used, such as a lip seal and an O-ring. A substantially rigid third or back-up sealing member 158 is also disposed within the seal groove 148 and further seals the sliding piston 144 relative to the bore 102. In the illustrated embodiment, the third sealing member 158 is a ring having a rectangular transverse section. The ring 158 may be formed from any desired material such as PTFE, nylon, and urethane.

The illustrated piston 144 is formed from aluminum. Alternatively, the piston 144 may be formed from any desired material such as carbon steel, stainless steel, copper, nickel and cobalt alloy and other metals, metal alloys, and non-metals.

A biasing member 160 is disposed within the attenuator bore 102 between the piston 144 and the second end 102B of the bore 102. The illustrated biasing member 160 is a plurality of disc springs 162, such as Belleville washers. Specifically, the illustrated biasing member 160 is an assembly comprising two pairs of Belleville washers 162. A disc shaped cap 164 is mounted within the third portion 108 of the bore 102 and closes the open end 102B of the bore 102. In the illustrated embodiment, the cap 164 is press-fit into the bore 102. Alternatively, the cap 164 may be mounted within the bore 102 by any other desired means. The illustrated cap 164 is formed from aluminum. Alternatively, the cap 164 may be formed from any desired material such as carbon steel, stainless steel, copper, nickel and cobalt alloy and other metals, metal alloys, and non-metals. A pin aperture 166 is centrally formed through the cap 164.

A second end 168B of a substantially cylindrical second pin 168 is mounted, such as by a press-fit, within the pin aperture 166 of the cap 164. The second pin 168 extends inwardly into bore 102 and defines an inside diameter positioning guide for the Belleville washers 162. The first end 168A of the second pin 168 extends inwardly (upwardly when viewing FIG. 2) into the second pin cavity 152 in the second end 144B of the piston 144, when the Belleville washers 162 are compressed as described herein.

The attenuator assembly 44 is movable between a first position as shown in FIG. 2 and a second position as shown in FIG. 3. In the first position, the force exerted on the piston 144 by the pressurized fluid in the attenuator bore 102 is less than the spring rate of the biasing member 160. The piston 144 is therefore positioned at a first extreme limit of travel relative to the HCU 100. In the second position, the force exerted on the piston 144 by the pressurized fluid in the attenuator bore 102 is greater than the spring rate of the biasing member 160. The piston 144 is therefore positioned at a second extreme limit of travel relative to the HCU 100, wherein the biasing member 160 is compressed by the piston 144.

In operation, as pressurized fluid flows into the attenuator chamber 102 through the inlet passageway 41, the pressure differential within the attenuator chamber 102 between the level of pressure in the inlet passageway 41 and the outlet passageway 43 increases. When the pressure within the attenuator chamber 102 increases to a first threshold value greater than the spring rate of the biasing member 160, the piston 144 is urged against the biasing member 160, compressing the disc springs 162. As pressurized fluid flows through the inlet passageway 41 and fills the attenuator chamber 102, fluid also flows through the variable orifice 38 and into the outlet passageway 43 at a predetermined first fluid flow rate. Fluid flows through the variable orifice 38 at flow rate determined by the size of the opening defined by the dampening passageway 120, the first cavity 122, and the position of the first movable member 132.

When the pressure within the attenuator chamber 102 increases past a second threshold value greater than the spring rate of the first movable member 132, the first movable member 132 deflects or moves (upwardly when viewing FIG. 3) from the first open position, as illustrated in FIG. 2, to any of a substantially infinite number of second open positions, thereby increasing fluid flow from the attenuator chamber 102 to the outlet passageway 43. One example of such a second open position is illustrated in FIG. 3. The movable member 132 may deflect until it reaches a fully deflected or fully open position (not shown), wherein fluid flows through the variable orifice 38 at a maximum or full fluid flow rate. As used herein, the terms “deflect” and “deflects” are defined as being caused to bend, deform, or otherwise change shape such as in response to an applied force. Alternatively, the movable member 132 may be configured to move between the first open position and the fully open position by any gradual movement of the movable member 132. For example, the movable member 132 may be configured to slide (to the right when viewing FIG. 2), thereby enlarging the opening at the outlet end 120B of the dampening passageway 120 and increasing fluid flow from the attenuator chamber 102 to the outlet passageway 43. Additionally, the movable member 132 may be configured to move axially (upwardly when viewing FIG. 2), thereby also enlarging the opening at the outlet end 120B of the dampening passageway 120 and increasing fluid flow from the attenuator chamber 102 to the outlet passageway 43.

Advantageously, the variable orifice 38 allows for the flow of fluid through the dampening passageway 120 and into the first outlet passageway 43 to be proportional to the differential pressure in the attenuator chamber 102. In the illustrated variable orifice 38, the movable member 132 is configured to move between a minimum flow position (shown in FIG. 2) and a maximum flow position (not shown) through a substantially infinite number of intermediate flow positions (one of which is shown in FIG. 3). In the minimum flow position, the movable member 132 is in a non-deflected position such that fluid flows through the dampening passageway 120 at a first fluid flow rate. In the second flow position, the movable member 132 is in a fully open or fully deflected position such that fluid flows through the dampening passageway 120 at a full fluid flow rate. In any of the intermediate flow positions, as shown in FIG. 3, the movable member 132 is in an intermediate-deflected position such that fluid flows through the dampening passageway 120 at a fluid flow rate intermediate of the first fluid flow rate and the full fluid flow rate. Thus, the size of the outlet end 120B changes substantially continuously between the first open position and the fully open position.

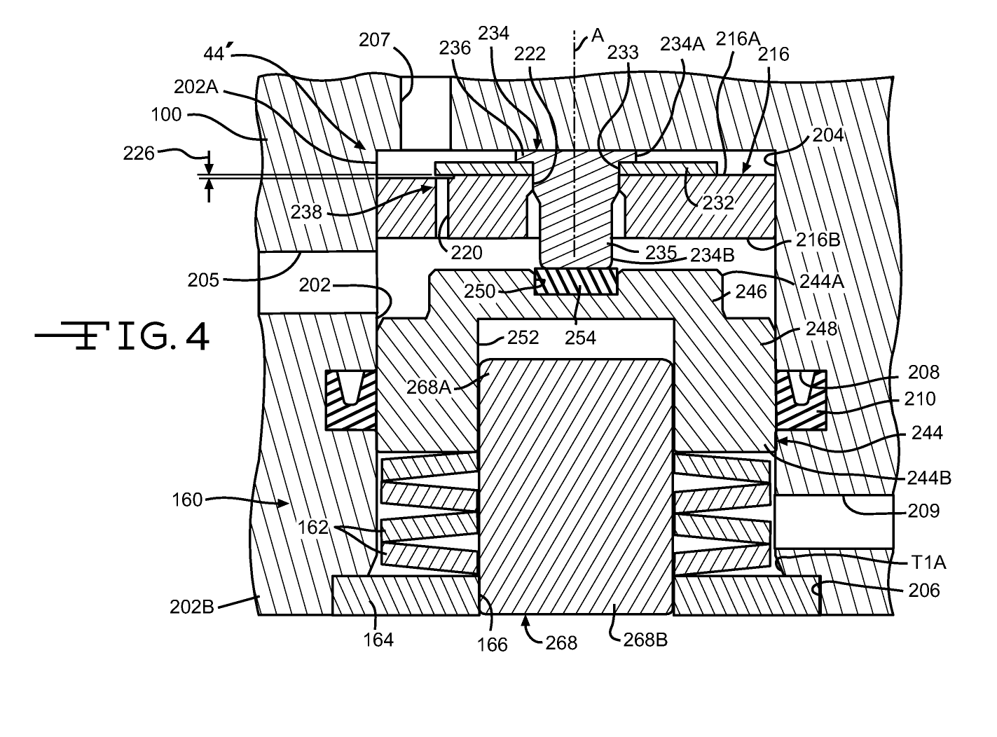

Referring now to FIG. 4, there is illustrated at 44′, a second embodiment of the attenuator assembly. In the illustrated embodiment, the attenuator assembly 44′ is disposed in the attenuator chamber or bore 202 of the HCU 100. The bore 202 has an axis A, a first end 202A (upper end when viewing FIG. 4), and a second or open end 202B, and may have more than one inside diameter. For example, the illustrated bore 202 includes a first portion 204 having a first diameter and a second portion 206 having a second diameter, wherein the second diameter is larger than the first diameter. The bore 202 also includes a first tapered portion T1A extending between the first portion 204 and the second portion 206.

An inlet passageway 205 is formed in the HCU 100 and allows pressurized fluid flow between the pump 36 and the bore 202. A first outlet passageway 207 is formed in the HCU 100 and connects the bore 202 to the wheel brakes FL, RR, FR, RL. A second outlet or vent passageway 209 is also formed in the HCU 100 and connects the bore 202 to a cavity (not shown).

A circumferentially extending seal groove 208 is formed in the wall of the bore 202. A sealing member 210 is disposed within the seal groove 208 and seals a sliding piston 244, described below, relative to the bore 202. In the illustrated embodiment, the sealing member 210 is an elastomeric lip seal 210. Alternatively, other types of sealing members may be used, such as a quad seal, an O-ring, and the like.

The attenuator assembly 44′ includes a first attenuator member 216 disposed within the attenuator bore 202. The first attenuator member 216 is substantially disc shaped and has a first end 216A (upper end when viewing FIG. 4) and a second end 216B opposite the first end 216A.

A dampening passageway 220 is formed through the first attenuator member 216 from the second end 216B to the first end 216A and defines a dampening fluid flow path. An aperture 222 is centrally formed through the first attenuator member 216. A first movable member 232 is mounted to the first end 216A of the first attenuator member 216. In the illustrated embodiment, the first movable member 232 is a first disc spring. The first movable member 232 includes a centrally formed aperture 233 and extends over the passageway 220, therefore extending into the dampening fluid flow path. The disc spring 232 defines a gap 226 between the passageway 220 and the disc spring 232. The dampening passageway 220, the first disc spring 232, and the gap 226 between the dampening passageway 220 and the first disc spring 232 cooperate to define a variable orifice 238, the operation of which is substantially the same as the operation of the variable orifice 38 and will not be further described herein.

A pin or fulcrum 234 includes a substantially cylindrical body 235 and a radially outwardly extending flange 236 defining a head at the first end 234A of the fulcrum 234. The body 235 of the fulcrum 234 is mounted within the aperture 233 of the disc spring 232 and the aperture 222 of the first attenuator member 216, such as by a press-fit. The flange 236 engages the wall of the first end 202A of the attenuator bore 202 and the disc spring 232 about the aperture 233, thus retaining the disc spring 232 against the first attenuator member 216. A second end 234B of the fulcrum 234 extends outwardly (downwardly when viewing FIG. 4) of the aperture 222. The illustrated fulcrum 234 is formed from aluminum. Alternatively, the fulcrum 234 may be formed from any desired material such as carbon steel, stainless steel, copper, nickel and cobalt alloy and other metals, metal alloys, and non-metals.

The attenuator assembly 44′ also includes a piston 244 slidably disposed within the attenuator bore 202. The piston 244 is substantially cylindrical and has a first end 244A (upper end when viewing FIG. 4) and a second end 244B. The piston 244 is stepped and includes a first portion 246 having a first diameter and a second portion 248 having a second diameter, wherein the diameter of the second portion 248 is larger than the diameter of the first portion 246.

A first cavity 250 is formed in the first end 244A of the piston 244. A second cavity 252 is formed in the second end 244B of the piston 244. A resilient member or bumper 254 is disposed in the first cavity 250. In the illustrated embodiment, resilient member 254 defines a moderately deformable member, and is formed from an elastomeric material, such as EPDM rubber. Alternatively, the resilient member 254 may be formed from any other deformable material, such as urethane, nitrile, or other polymer.

The second end 234B of the fulcrum 234 engages the resilient member 254. The fulcrum 234 defines a stop that prevents the piston 244 from moving further inwardly (upwardly when viewing FIG. 4). The illustrated piston 244 is formed from aluminum. Alternatively, the piston 244 may be formed from any desired material such as carbon steel, stainless steel, copper, nickel and cobalt alloy and other metals, metal alloys, and non-metals.

The biasing member 160 is disposed within the attenuator bore 202 between the piston 244 and the second end 202B of the bore 202. The disc shaped cap 164 is mounted within the second portion 206 of the bore 202 and closes the second end 202B of the bore 202.

A second end 268B of a substantially cylindrical member or second pin 268 is mounted, such as by a press-fit, within the pin aperture 166 of the cap 164. The second pin 268 extends inwardly into bore 202 and defines an inside diameter positioning member or guide for the Belleville washers 162. A first end 268A of the second pin 268 extends inwardly (upwardly when viewing FIG. 4) into the pin cavity 252 in the second end 244B of the piston 244, when the Belleville washers 162 are compressed as described above.

As described above regarding the attenuator assembly 44, the attenuator assembly 44′ is movable between a first position as shown in FIG. 4 and a second position (not shown). In the first position, the spring rate of the biasing member 160 is greater than a force exerted on the piston 244 by the pressurized fluid in the attenuator bore 202. The piston 244 is therefore at a first extreme of travel. In the second position, the spring rate of the biasing member 160 is less than a force exerted on the piston 244 by the pressurized fluid in the attenuator bore 202. The piston 244 is therefore at a second extreme of travel, wherein the biasing member 160 is compressed by the piston 244.

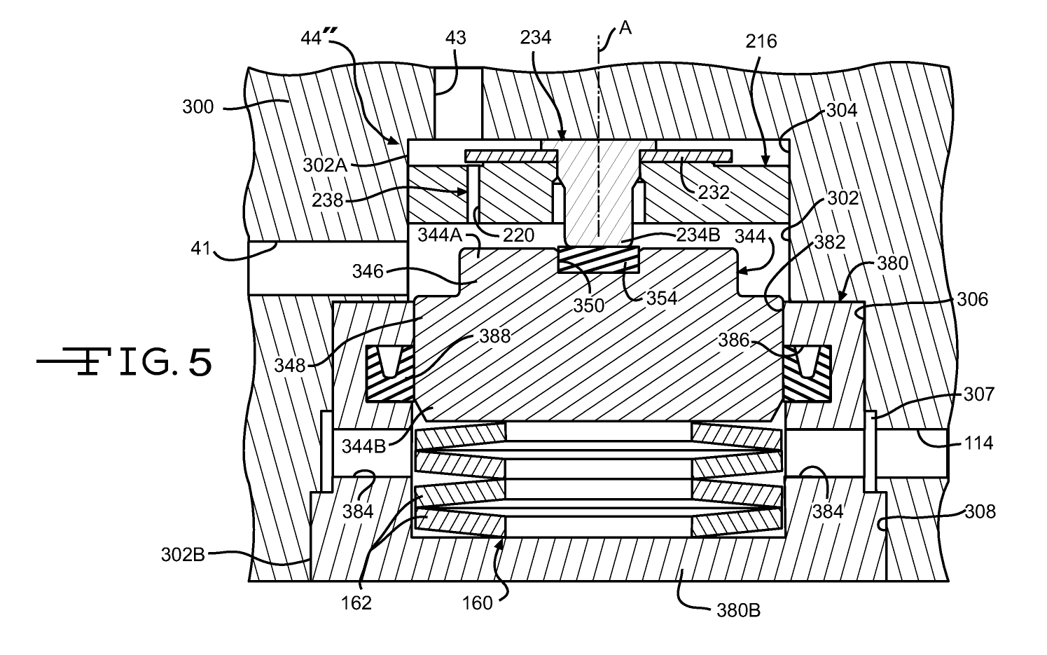

Referring now to FIG. 5, there is illustrated at 44″, a third embodiment of the attenuator assembly. In the illustrated embodiment, the attenuator assembly 44″ is disposed in an attenuator bore or chamber 302 of the HCU 300. The bore 302 has an axis A, a first end 302A (upper end when viewing FIG. 5) and a second or open end 302B and may have more than one inside diameter. For example, the illustrated bore 302 includes a first portion 304 having a first diameter, a second portion 306 having a second diameter, wherein the second diameter is larger than the first diameter, and a third portion 308 having a third diameter, wherein the third diameter is larger than the second diameter.

The inlet passageway 41 is formed in the HCU 300 and allows pressurized fluid flow between the pump 36 and the bore 302. The first outlet passageway 43 is formed in the HCU 300 and connects the bore 302 to the wheel brakes FL, RR, FR, RL. The second outlet or vent passageway 114 is also formed in the HCU 300 and connects the bore 302 to a cavity (not shown).

A sleeve 380 is disposed within the second and third portions 306 and 308 of the bore 302. The sleeve 380 includes a piston bore 382. Transverse passageways 384 are formed in the sleeve 380 and connect the bore 382 to a circumferential channel 307 formed in the bore 302.

A circumferentially extending seal groove 386 is formed in the wall of the bore 382. A sealing member 388 is disposed within the seal groove 386 and seals a sliding piston 344, described below, relative to the bore 382. In the illustrated embodiment, the sealing member 388 is an elastomeric lip seal 388. Alternatively, other types of sealing members may be used, such as a quad seal and an O-ring.

The attenuator assembly 44″ includes the first attenuator member 216, the first disc spring 232, and the fulcrum 234, described above. The attenuator assembly 44″ also includes the piston 344 slidably disposed within the piston bore 382. The piston 344 is substantially cylindrical and has a first end 344A (upper end when viewing FIG. 5) and a second end 344B. The piston 344 is stepped and includes a first portion 346 having a first diameter and a second portion 348 having a second diameter, wherein the diameter of the second portion 348 is larger than the diameter of the first portion 346.

A first cavity 350 is formed in the first end 344A of the piston 344. A resilient member 354 is disposed in the first cavity 350. In the illustrated embodiment, resilient member 354 defines a moderately deformable member, and is formed from an elastomeric material, such as EPDM rubber. Alternatively, the resilient member 354 may be formed from any other deformable material, such as urethane, nitrile, or other polymer.

The second end 234B of the fulcrum 234 engages the resilient member 354. The fulcrum 234 defines a stop that prevents the piston 344 from moving further inwardly (upwardly when viewing FIG. 5). The illustrated piston 344 is formed from aluminum. Alternatively, the piston 244 may be formed from any desired material such as carbon steel, stainless steel, copper, nickel and cobalt alloy and other metals, metal alloys, and non-metals.

The biasing member 160 is disposed within the piston bore 382 between the piston 344 and a closed end 380B of the sleeve 382. The piston bore 382 defines an outside diameter positioning member or guide for the Belleville washers 162.

As described above regarding the attenuator assemblies 44 and 44′, the attenuator assembly 44″ is movable between a first position as shown in FIG. 5 and a second position (not shown). In the first position, the spring rate of the biasing member 160 is greater than a force exerted on the piston 344 by the pressurized fluid in the attenuator bore 302. The piston 344 is therefore at a first extreme of travel. In the second position, the spring rate of the biasing member 160 is less than a force exerted on the piston 344 by the pressurized fluid in the attenuator bore 302. The piston 344 is therefore at a second extreme of travel, wherein the biasing member 160 is compressed by the piston 344.

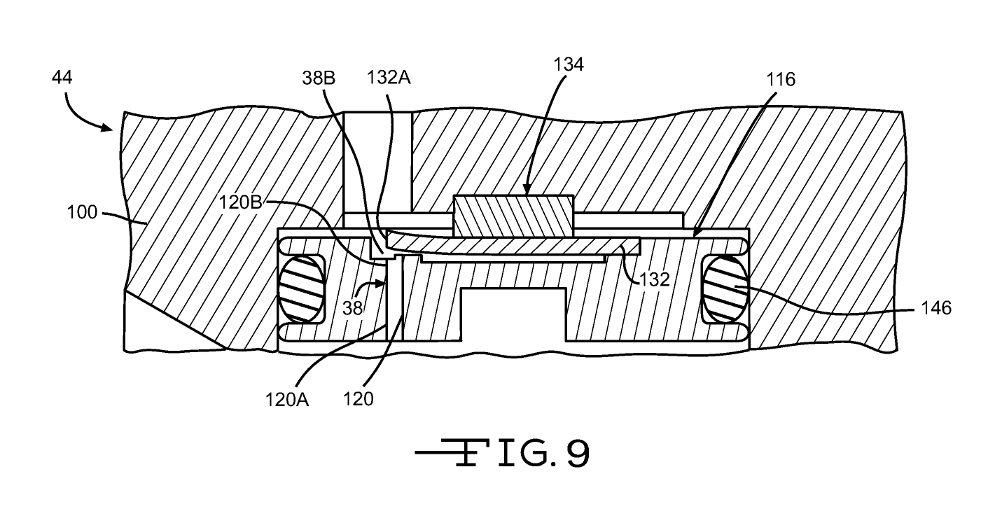

FIG. 8 is a graph that illustrates a first curve (identified as curve X) that shows the relationship of the rate of fluid flowing through the variable orifice 38 as a function of the differential pressure there across. FIG. 8 also illustrates a second curve (identified as curve Y) that shows the relationship of the rate of fluid flowing through a prior art switchable orifice 38 (such as shown in German Patent Application No. DE 10 2009 006 980 A1 described above) as a function of the differential pressure there across.

As described above, the piston pump 36 generates pulses of pressurized fluid that are supplied through the attenuator assembly 44 to the valve arrangements 26 and the wheel brake cylinders 28. Each of these pulses of pressurized fluid creates a pressure differential across the orifice of the attenuator assembly 44 that transitions from a minimum value (at the beginning of each pulse) to a maximum value (at the peak of each pulse). At some threshold (identified as the Switch Point in FIG. 8), the pressure differential across the prior art switchable orifice shown in German Patent Application No. DE 10 2009 006 980 A1 increases to a sufficiently large magnitude that it causes the ball-check valve 11 to open. As a result, the size of the prior art switchable orifice is effectively increased immediately and, the pressurized fluid can flow therethrough at a much larger rate than before.

This operation of the prior art switchable orifice is graphically illustrated by curve Y in FIG. 8. In Region I of the graph (which covers the increase of the differential pressure from the minimum value to the Switch Point), the flow rate of the fluid increases at a first generally linear rate as the differential pressure increases. In Region II of the graph (which covers the increase of the differential pressure from the Switch Point to the maximum value), the flow rate of the fluid increases at a second generally linear rate as the differential pressure increases, wherein the second generally linear rate is significantly larger than the first generally linear rate. However, the transition from the first generally linear rate to the second generally linear rate (which occurs in the immediate vicinity of the Switch Point) is undesirably abrupt and uncontrolled.

The operation of the variable orifice 38 of this invention is graphically illustrated by curve X in FIG. 8. In the leftmost portions of Region I of the graph (which represent the smaller pressure differentials that do not cause any significant deformation of the first movable member 132), the flow rate of the fluid increases at a first generally linear rate as the differential pressure increases. In the rightmost portions of Region II of the graph (which represent the larger pressure differentials that cause deformation of the first movable member 132 to the fully deformed position), the flow rate of the fluid increases at a second generally linear rate as the differential pressure increases, wherein the second generally linear rate is significantly larger than the first generally linear rate. In the middle portions of graph (which represent all of the intermediate pressure differentials that gradually cause increasing deformation of the first movable member 132), the flow rate of the fluid increases gradually from the first generally linear rate to the second generally linear rate. Thus, the transition from the first generally linear rate to the second generally linear rate is desirably smooth and controlled.

The principle and mode of operation of the attenuator have been described in its preferred embodiments. However, it should be noted that the attenuator described herein may be practiced otherwise than as specifically illustrated and described without departing from its scope.

What is claimed is:

1. An attenuator assembly located in an attenuator chamber of a housing in a vehicle braking system, the attenuator assembly comprising:
an orifice defining a fluid dampening flow path and having an outlet opening; and
a biasing member defining a closing member of the orifice;
wherein the size of the outlet opening changes continuously between a first open position and a second open position.

2. The attenuator assembly according to claim 1, wherein the size of the outlet opening changes as the shape of the closing member changes in response to a force exerted on the closing member.

3. The attenuator assembly according to claim 2, wherein the force exerted on the closing member varies as a function of a fluid flow rate through the orifice.

4. The attenuator assembly according to claim 2, wherein the force exerted on the closing member varies as a function of differential fluid pressure in the attenuator chamber.

5. The attenuator assembly according to claim 2, wherein the force exerted on the closing member varies as a function of a fluid flow rate through the orifice and as a function of differential fluid pressure in the attenuator chamber.

6. The attenuator assembly according to claim 1, wherein fluid flow through the orifice is substantially infinitely variable between a minimum fluid flow rate defined when the orifice is in the first open position, and a maximum fluid flow rate defined when the orifice is in the second open position.

7. The attenuator assembly according to claim 1, wherein when the vehicle braking system operates at a relatively low flow rate, the attenuator assembly operates at a relatively high differential pressure.

8. The attenuator assembly according to claim 1, wherein when the vehicle braking system operates at a relatively higher flow rate, the attenuator assembly operates at a relatively low differential pressure.

9. The attenuator assembly according to claim 7, wherein when the vehicle braking system operates at a relatively higher flow rate, the attenuator assembly operates at a relatively low differential pressure.

10. A vehicle braking system including a variable speed motor driven piston pump for supplying pressurized fluid pressure to the wheel brakes through a valve arrangement, and an attenuator assembly connected to a pump outlet for dampening pump output pressure pulses prior to application of the wheel brakes, the attenuator assembly located in an attenuator chamber of a housing, the attenuator assembly comprising:
an orifice defining a fluid dampening flow path and having an outlet opening; and
a biasing member defining a closing member of the orifice;
wherein the size of the outlet opening changes continuously between a first open position and a second open position.

11. The attenuator assembly according to claim 10, wherein the size of the outlet opening changes as the shape of the closing member changes in response to a force exerted on the closing member.

12. The attenuator assembly according to claim 11, wherein the force exerted on the closing member varies as a function of a fluid flow rate through the orifice.

13. The attenuator assembly according to claim 11, wherein the force exerted on the closing member varies as a function of differential fluid pressure in the attenuator chamber.

14. The attenuator assembly according to claim 11, wherein the force exerted on the closing member varies as a function of a fluid flow rate through the orifice and as a function of differential fluid pressure in the attenuator chamber.

15. The attenuator assembly according to claim 10, wherein fluid flow through the orifice is substantially infinitely variable between a minimum fluid flow rate defined when the orifice is in the first open position, and a maximum fluid flow rate defined when the orifice is in the second open position.

16. The attenuator assembly according to claim 10, wherein when the vehicle braking system operates at a relatively low flow rate, the attenuator assembly operates at a relatively high differential pressure.

17. The attenuator assembly according to claim 10, wherein when the vehicle braking system operates at a relatively high flow rate, the attenuator assembly operates at a relatively low differential pressure.

18. A vehicle braking system including a slip control system,
the slip control system operable in an electronic stability control (ESC) mode to automatically and selectively apply wheel brakes in an attempt to stabilize a vehicle when an instability condition has been sensed,
the slip control system including a variable speed motor driven piston pump for supplying pressurized fluid pressure to the wheel brakes through a valve arrangement,
the slip control system further including an attenuator assembly connected to a pump outlet for dampening pump output pressure pulses prior to application of the wheel brakes, the attenuator assembly located in an attenuator chamber of a housing, the attenuator assembly comprising:
an orifice defining a fluid dampening flow path and having an outlet opening; and
a biasing member defining a closing member of the orifice;
wherein the size of the outlet opening changes continuously between a first open position and a second open position.

19. The attenuator assembly according to claim 18, wherein the size of the outlet opening changes as the shape of the closing member changes in response to a force exerted on the closing member.

20. The attenuator assembly according to claim 19, wherein the force exerted on the closing member varies as a function of a fluid flow rate through the orifice.

21. The attenuator assembly according to claim 19, wherein the force exerted on the closing member varies as a function of differential fluid pressure in the attenuator chamber.
